(19) United States
(12) Patent Application Publication
(10) Pub. No.: US 2026/0027994 A1
(43) Pub. Date: Jan. 29, 2026

(54) REAR WIPER AND VEHICLE

(71) Applicant: VALEO SYSTEMES D'ESSUYAGE, La Verriere (FR)

(72) Inventors: Xu CHENG, La Verriere (FR); Shuqian TIAN, La Verriere (FR)

(73) Assignee: VALEO SYSTEMES D'ESSUYAGE, La Verriere (FR)

(21) Appl. No.: 19/144,007

(22) PCT Filed: Dec. 18, 2023
(86) PCT No.: PCT/EP2023/086421

§ 371 Date: Jun. 27, 2025

(30) Foreign Application Priority Data
Dec. 30, 2022 (CN) 202223612377.1

(51) Int. Cl. B60S 1/58; B60S 1/34

(52) U.S. Cl. CPC B60S 1/583; B60S 1/3456; B60S 1/3438

(57) ABSTRACT

The present disclosure provides a rear wiper and a vehicle. The rear wiper includes an arm support, having a first end portion and a second end portion, wherein the arm support is driven to pivot at the first end portion thereof, such that the rear wiper wipes a rear windshield, and a wiper arm, having a first connecting end, wherein the first connecting end is connected to the second end portion of the arm support, and the wiper arm is rotatable relative to the arm support between a first position close to the rear windshield and a second position away from the rear windshield. The wiper arm includes a stop part, which is located at the first connecting end and is capable of abutting against the arm support, and when the stop part abuts against the arm support, the wiper arm is in the second position.

### TECHNICAL FIELD

The present disclosure relates to a rear wiper and a vehicle comprising the rear wiper, in particular to a rear wiper with a stop part on a wiper arm.

### BACKGROUND OF THE INVENTION

A rear wiper for a vehicle reciprocates against a rear windshield in a wiping operation, so as to scrape the rain, dust, etc. on the rear windshield. Typically, the rear wiper comprises an arm support, a wiper arm and a wiper blade, which are successively connected to each other. A first connecting portion of the wiper arm is pivotally connected to the arm support, and a second connecting portion of the wiper arm is connected to the wiper blade. When the wiper arm is located in a first position, the wiper blade abuts against the rear windshield of the vehicle and is driven to perform the wiping operation in a reciprocating manner. When the wiper blade needs to be replaced, an operator needs to manually rotate the wiper arm relative to the arm support in the direction away from the rear windshield until the wiper arm stands up relative to the arm support.

However, the rear wiper with the above structure has the following problems: when a vehicle is cleaned by a car washing machine, a washing brush of the car washing machine may hang the wiper to erect same relative to the arm support, continuing the operation of cleaning in this case may easily cause damage to the wiper. In addition, more and more vehicles will have the rear wiper mounted on the top of the rear windshield, in this way, there is a risk that the wiper arm may collide with the roof of the body (i.e., a spoiler) when the operator manually lifts the wiper arm.

In order to solve the above problems, some manufacturers have a rubber element additionally mounted below the end of the wiper arm near the arm support to limit the rotation/lifting angle of the wiper arm relative to the arm support. However, this method requires suitable rubber parts to be additionally made and assembled, and the rubber parts have low elastic strength (i.e., poor rigidity), which makes them unable to effectively limit the lifting angle of the wiper arm.

Therefore, those skilled in the art are committed to developing a new rear wiper to solve the above defects of the prior art.

### SUMMARY OF THE INVENTION

An object of the present disclosure is to provide a rear wiper, which can effectively limit a rotation angle of a wiper arm, so that the wiper arm is not easily damaged when being washed by a car washing machine, and when the rear wiper is mounted to the top of the rear windshield, the risk of colliding with the roof of the body (i.e., a spoiler) caused by lifting the wiper arm can be avoided. Moreover, the production and assembly time may be effectively saved on, thereby reducing costs, and also solving the problem of being time-consuming and laborious due to the need to additionally manufacture and assemble other components in the prior art.

The present disclosure provides a rear wiper for a rear windshield of a vehicle. The rear wiper comprises: an arm support, having a first end portion and a second end portion, wherein the arm support is driven to pivot at the first end portion thereof, such that the rear wiper wipes a rear windshield; and a wiper arm, having a first connecting end, wherein the first connecting end is connected to the second end portion of the arm support, and the wiper arm is rotatable relative to the arm support between a first position close to the rear windshield and a second position away from the rear windshield. The wiper arm comprises a stop part, which is located at the first connecting end of the wiper arm and is capable of abutting against the arm support, and when the stop part abuts against the arm support, the wiper arm is in the second position.

In the present disclosure, by means of the design that the wiper arm comprises the stop part, other components can be prevented from being additionally provided, and the rotation angle of the wiper arm may be effectively limited, so that the wiper arm is not easily damaged when being washed by the car washing machine, and when the rear wiper is mounted to the top of the rear windshield, the risk of colliding with the roof of the body (i.e., the spoiler) caused by lifting the wiper arm can be avoided.

In one or more embodiments, the second end portion of the arm support comprises a U-shaped groove open to the wiper arm, the first connecting end of the wiper arm has a main body, and the stop part protrudes outward in a transverse direction from the main body, and is capable of abutting against support legs of the U-shaped groove.

In one or more embodiments, the main body falls at least partially into the U-shaped groove.

In one or more embodiments, the stop part is located on the side of the U-shaped groove away from the rear windshield.

In one or more embodiments, the stop part has a shape of extending in a longitudinal direction.

In the present disclosure, the stop part is arranged to have a shape of extending in the longitudinal direction, so that the strength of the stop part may be improved, and an extrusion stress is dispersed when the stop part abuts against the arm support, avoiding the risk of damage to the stop part caused by stress concentration.

In one or more embodiments, the stop part comprises a first stop component and a second stop component located on two sides of the main body in the transverse direction.

In the present disclosure, the stop part is arranged to comprise the first stop component and the second stop component located on two sides of the main body, so that the extrusion stress may be evenly distributed on the two sides of the main body when the stop part abuts against the arm support.

In one or more embodiments, the stop part is provided with a reinforcing rib on the side away from the arm support.

In one or more embodiments, the reinforcing rib extends outward in the transverse direction from the main body.

In the present disclosure, the reinforcing rib is provided on the stop part, so that the strength of the stop part may be further improved, and the rotation/lifting angle of the wiper arm is effectively limited.

In one or more embodiments, the stop part and the main body are formed as one piece.

In the present disclosure, the stop part and the main body are formed as one piece, so that the connection strength between the stop part and the main body may be improved, and the production and assembly time of the stop part may be effectively saved on, thereby reducing costs, and also solving the problem of being time-consuming and laborious due to the need to additionally manufacture and assemble other components in the prior art.

The present disclosure further provides a vehicle, comprising the rear wiper described above.

### BRIEF DESCRIPTION OF DRAWINGS

FIG. 1 is a perspective view of a rear wiper according to an embodiment of the present disclosure;

FIG. 2 is a partial side view of a rear wiper according to an embodiment of the present disclosure, with a wiper arm in a first position;

FIG. 3 is a partial side view of a rear wiper according to an embodiment of the present disclosure, with a wiper arm in a second position;

FIG. 4 is a partial top view of a rear wiper according to an embodiment of the present disclosure;

FIG. 5 is a partial perspective view of a wiper arm according to an embodiment of the present disclosure; and

FIG. 6 is a perspective view of the wiper arm as shown in FIG. 5 from another viewing angle.

### DETAILED DESCRIPTION OF THE INVENTION

Some specific embodiments will be described below to explain implementations of the present disclosure, and those skilled in the art can easily understand other advantages and effects of the present disclosure from what is disclosed in this description.

It should be noted that the structures, proportions, sizes, etc. shown in the drawings of this description are intended, in cooperation with what is disclosed in the description, for easy understanding and perusal by those skilled in the art, rather than being intended to limit the conditions for implementing the present disclosure, so they do not have any substantive technical meaning, and any modifications to the structure, changes in the proportion relationship, or adjustments in size, without affecting the efficacy and objectives that may be achieved by the present disclosure, shall fall within the scope of the technical content disclosed herein. The terms that are quoted in the description such as “up” and “one” are only intended for convenience of description rather than to limit the feasible scope of the present disclosure. Changes or adjustments made to relative relationships under no actual alteration of the technical content should be seen as the feasible scope of the present disclosure.

In order to understand the present disclosure more clearly, various embodiments of the present disclosure will be described below in conjunction with the accompanying drawings.

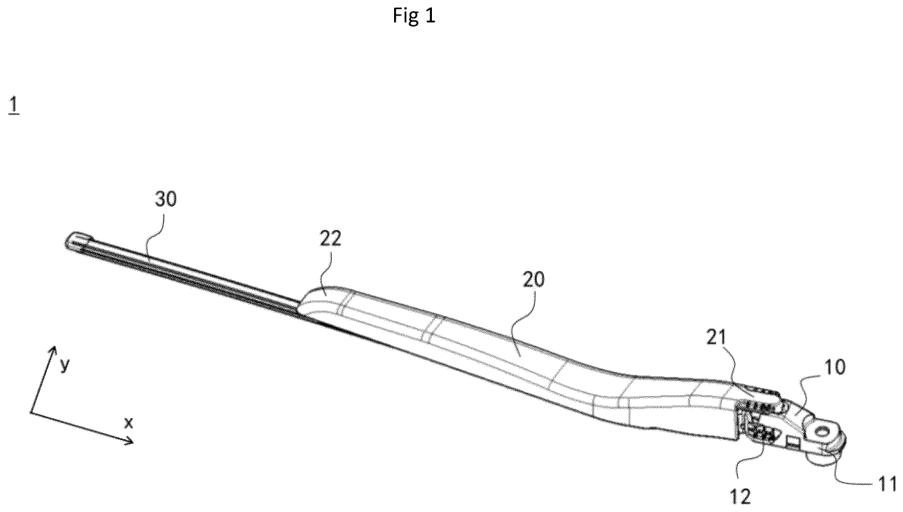

FIG. 1 shows a perspective view of a rear wiper 1 for a motor vehicle. As shown in the figure, the rear wiper 1 comprises an arm support 10, a wiper arm 20 and a wiper blade 30, which are successively connected to each other.

In a specific embodiment, the arm support 10 can be roughly in the form of a bar, and has a first end portion 11 and a second end portion 12. The wiper arm 20 has an elongated shape that extends in a longitudinal direction x, wherein the longitudinal direction x is a lengthwise direction of the wiper arm 20, a transverse direction y is perpendicular to the longitudinal direction x, and the transverse direction y is a widthwise direction of the wiper arm 20. The wiper arm 20 comprises a first connecting end 21 and a second connecting end 22, wherein the first connecting end 21 of the wiper arm 20 is connected to the second end portion 12 of the arm support 10, and the second connecting end 22 of the wiper arm 20 is connected to the wiper blade 30 abutting against the rear windshield.

When the rear wiper 1 is mounted to the vehicle, the first end portion 11 of the arm support 10 is connected to a driving mechanism (not shown). The driving mechanism may, for example, be a drive motor and/or a linkage mechanism mounted in the vehicle, and the first end portion of the arm support 10 is rotatably and fixedly connected to an output shaft of the drive motor and/or the linkage mechanism, so as to be driven and reciprocate.

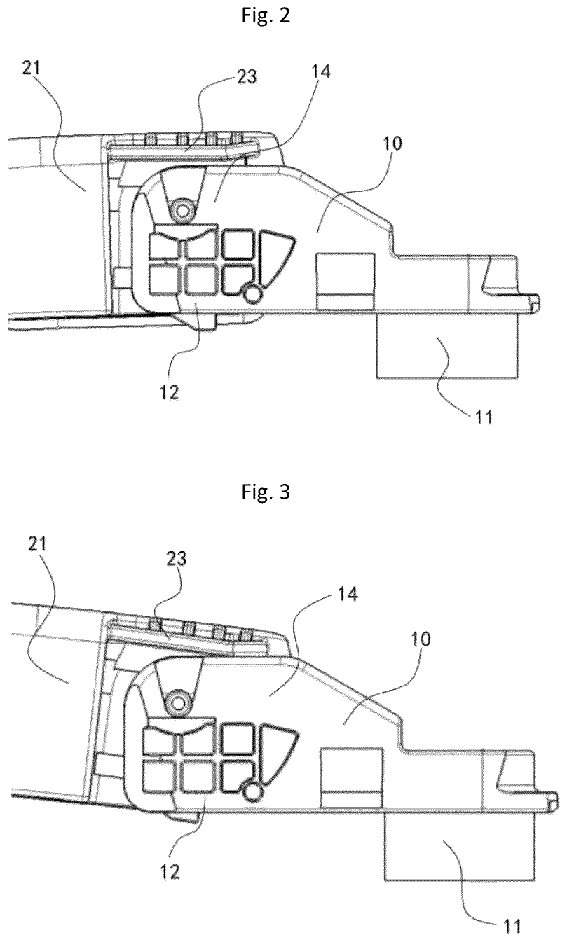

The second end portion 12 of the arm support 10 is pivotally connected to the first connecting end 21 of the wiper arm 20, such that the wiper arm 20 is rotatable relative to the arm support 10 between a first position close to the windshield and a second position away from the windshield. FIG. 2 shows a partial side view of the rear wiper 1 when the wiper arm 20 is in the first position; and FIG. 3 shows a partial side view of the rear wiper 1 when the wiper arm 20 is in the second position. When the wiper arm 20 is in the first position, the arm support 10 may drive the wiper arm 20 and the wiper blade 30 to reciprocate relative to the rear windshield of the vehicle under the drive of the driving mechanism, so as to scrape the rain, dust, etc. on the rear windshield. When the wiper arm 20 is in the second position, the wiper blade 30 may be replaced.

In order to limit the angle at which the wiper arm 20 is rotated/lifted relative to the arm support 10 (hereinafter referred to collectively as a rotation/lifting angle of the wiper arm 20), the wiper arm 20 of the present disclosure comprises a stop part 23, as shown in FIG. 2 and FIG. 3, the stop part 23 being located at the first connecting end 21 of the wiper arm 20 and being capable of abutting against the arm support 10. When the stop part 23 abuts against the arm support 10 (as shown in FIG. 3), the wiper arm 20 is in the second position. In an embodiment, an included angle between the first position and the second position of the wiper arm 20 can be set to approximately less than 30 degrees, so that the wiper arm is not easily damaged when being washed by a car washing machine, and when the rear wiper 1 is mounted to the top of the rear windshield, the risk of colliding with the roof of the body (i.e., a spoiler) caused by lifting the wiper arm 20 can be avoided.

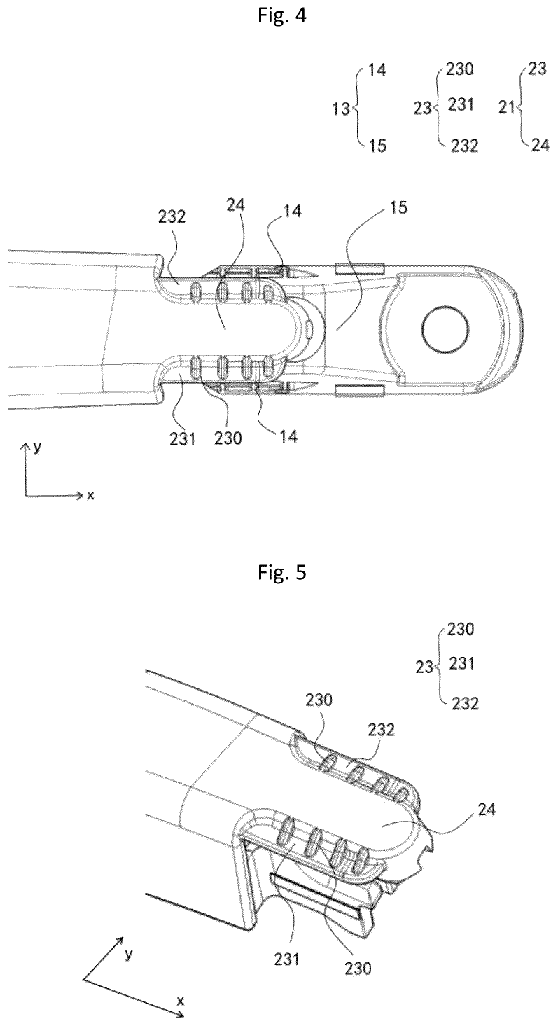

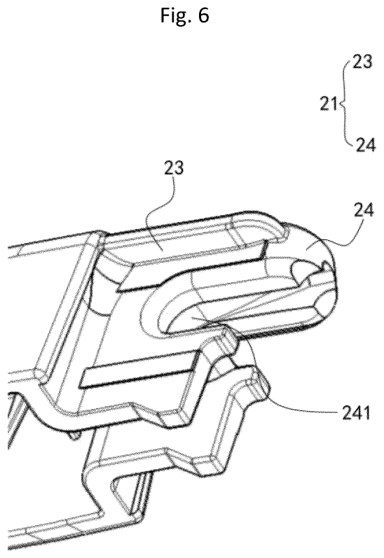

In an embodiment, with reference to FIG. 4, the second end portion 12 of the arm support 10 comprises a U-shaped groove 13 open to the wiper arm 20, the U-shaped groove 13 having two support legs 14 arranged in the transverse direction y and a connecting portion 15 connecting the two support legs 14. With reference to FIG. 5 and FIG. 6, the first connecting end 21 of the wiper arm 20 has a main body 24, the main body 24 having a tapered shape on a side close to the second connecting end 22 (this position being hereinafter referred to collectively as a tapered place of the main body 24), such that the width of the main body 24 is relatively small. The main body 24 is at least partially inserted into the U-shaped groove 13 of the arm support 10 (as shown in FIG. 1, FIG. 2 and FIG. 4), and is pivoted to the U-shaped groove 13 of the arm support 10 via a pin shaft (not shown) and a spring (not shown). Specifically, the main body 24 has a C-shaped opening 241 (as shown in FIG. 6) facing the arm support 10, is configured to cooperate with the pin shaft arranged between the two support legs 14 of the U-shaped groove 13, and enables the wiper arm 20 to be pivoted to the arm support 20 via the spring having two ends respectively connected to the arm support 10 and the wiper arm 20, wherein the arrangement of the spring and the pin shaft is well-known to a person skilled in the art, and will no longer be repeated herein.

With continued reference to FIG. 2 to FIG. 6, the first connecting end 21 of the wiper arm 20 further has a stop part 23, the stop part 23 being capable of protruding outward from the main body 24 in the transverse direction y, and being capable of abutting against the support legs 14 of the U-shaped groove 13 of the arm support 10. In an embodiment, the stop part 23 may be located on the side of the U-shaped groove 13 of the arm support 10 away from the rear windshield, i.e. at an upper part of the U-shaped groove 13 as shown in FIG. 2. Of course, the present disclosure is not limited to this, for example, the stop part 23 may also be located on the side of the U-shaped groove 13 close to the rear windshield (a lower part of the U-shaped groove 13 as shown in FIG. 2), as long as it can abut against the arm support 10, and then limits the rotation/lifting angle of the wiper arm 20.

In an embodiment, as shown in FIG. 4 and FIG. 5, the stop part 23 may comprise a first stop component 231 and a second stop component 232 located on two sides of the main body 24 in the transverse direction y, to respectively abut against the two support legs 14 of the U-shaped groove 13, such that an extrusion stress may be evenly distributed on the two sides of the main body 24. The first stop component 231 and the second stop component 232 may have a shape (an elongated shape as shown in FIG. 5) that extends in the longitudinal direction x from the tapered place of the main body 24, thus the strength of the stop part 23 can be enhanced, and the extrusion stress is dispersed when the stop part abuts against the U-shaped groove 13, avoiding the risk of damage to the stop part 23 caused by stress concentration.

In addition, the designer can set the stop part 23 to different lengths and/or thicknesses according to the required rotation angle of the wiper arm 20 so as to meet different needs. Of course, the present disclosure is also not limited to the above shapes and positions of the first stop component 231 and the second stop component 232. For example, the first stop component 231 and the second stop component 232 may also be bosses that are positioned on the two sides of the main body 24 and extend outward in the transverse direction y, and the specific positions of the first stop component and the second stop component may be arranged according to the rotation angle of the wiper arm 20.

In an embodiment, the stop part 23 and the main body 24 may be formed as one piece, for example, from metal materials or engineering plastics by an injection molding process, so as to improve the connection strength between the stop part 23 and the main body 24, and to effectively save on the production and assembly time of the stop part 23. However, the present disclosure is not limited to this, for example, the stop part 23 may also be connected to the main body 24 by means of welding or a fastener, as long as the stop part 23 has greater rigidity and can effectively limit the rotation/lifting angle of the wiper arm 20.

With continued reference to FIG. 5, the stop part 23 may also be provided with at least one reinforcing rib 25, the reinforcing rib 25 may be located on the side of the stop part 23 away from the arm support 10, and may extend outward in the transverse direction y from the main body 14, so as to further improve the strength of the stop part 23, and to effectively limit the rotation/lifting angle of the wiper arm 20.

Although the above embodiment of the present disclosure is described as the stop part 23 comprising the first stop component 231 and the second stop component 232, the present disclosure is not limited to this, for example, the stop part 23 may also have only one of the first and the second stop component 231, 232, as long as the rotation/lifting angle of the wiper arm 20 can be limited.

In addition, the above embodiment of the present disclosure is mainly described as the stop part 23 protruding outward in the transverse direction y from the main body 24, and abutting against the support legs 14 of the U-shaped groove 13 to limit the rotation angle of the wiper arm 20. However, the present disclosure is not limited to this, for example, the stop part 23 may also protrude outward in the longitudinal direction x from a free end of the main body 24, and abuts against the connecting portion 15 of the U-shaped groove 13 to limit the rotation angle of the wiper arm 20, and may also adjust the required rotation angle of the wiper arm 20 by setting the stop part 23 to different thicknesses.

The present disclosure provides a rear wiper, by means of the design that the first connecting end of the wiper arm comprises the stop part, other components can be prevented from being additionally provided, and the rotation angle of the wiper arm may be effectively limited, so that the wiper arm is not easily damaged when being washed by the car washing machine, and when the rear wiper is mounted to the top of the rear windshield, the risk of colliding with the roof of the body (i.e., the spoiler) caused by lifting the wiper arm can be avoided. Moreover, in the present disclosure, the stop part and the main body of the first connecting end are formed as one piece, so that the connection strength between the stop part and the main body may be improved, and the production and assembly time of the stop part may be effectively saved on, thereby reducing costs, and also solving the problem of being time-consuming and laborious due to the need to additionally manufacture and assemble other components in the prior art.

The present disclosure further provides a vehicle, comprising the rear wiper described above.

Exemplary implementations of the rear wiper and the vehicle provided by the present disclosure are described above with reference to preferred embodiments, however, it will be understood by those skilled in the art that various variations and modifications may be made to the specific embodiments without departing from the concept of the present disclosure, and various technical features and structures proposed in the present disclosure may be combined without exceeding the scope of protection of the present disclosure. The scope of protection of the present disclosure is determined by the appended claims.

What is claimed is:

1. A rear wiper for a rear windshield of a vehicle, wherein the rear wiper comprises:
an arm support, having a first end portion and a second end portion, wherein the arm support is driven to pivot at the first end portion thereof, such that the rear wiper wipes the rear windshield; and
a wiper arm, having a first connecting end, wherein the first connecting end is connected to the second end portion of the arm support, and the wiper arm is rotatable relative to the arm support between a first position close to the rear windshield and a second position away from the rear windshield,
wherein the wiper arm includes a stop part, the stop part is located at the first connecting end of the wiper arm and is capable of abutting against the arm support, and when the stop part abuts against the arm support, the wiper arm is in the second position.

2. The rear wiper of claim 1, wherein the second end portion of the arm support includes a U-shaped groove open to the wiper arm, the first connecting end of the wiper arm has a main body, and the stop part protrudes outward in a transverse direction from the main body, and is capable of abutting against support legs of the U-shaped groove.

3. The rear wiper of claim 2, wherein the main body falls at least partially into the U-shaped groove.

4. The rear wiper of claim 3, wherein the stop part is located on the side of the U-shaped groove away from the rear windshield.

5. The rear wiper of claim 4, wherein the stop part has a shape of extending in a longitudinal direction.

6. The rear wiper of claim 4, wherein the stop part includes a first stop component and a second stop component located on two sides of the main body in the transverse direction.

7. The rear wiper of claim 6, wherein the stop part is provided with a reinforcing rib on the side away from the arm support.

8. The rear wiper of claim 7, wherein the reinforcing rib extends outward in the transverse direction from the main body.

9. The rear wiper of claim 7, wherein the stop part and the main body are formed as one piece.

10. A vehicle, comprising a rear wiper, wherein the rear wiper includes an arm support, having a first end portion and a second end portion, wherein the arm support is driven to pivot at the first end portion thereof, such that the rear wiper wipes the rear windshield, and a wiper arm, having a first connecting end, wherein the first connecting end is connected to the second end portion of the arm support, and the wiper arm is rotatable relative to the arm support between a first position close to the rear windshield and a second position away from the rear windshield, wherein the wiper arm includes a stop part, the stop part is located at the first connecting end of the wiper arm and is capable of abutting against the arm support, and when the stop part abuts against the arm support, the wiper arm is in the second position.
